(19) United States
(12) Patent Application Publication
(10) Pub. No.: US 2009/0289561 A1
(43) Pub. Date: Nov. 26, 2009

(54) FLICKER-FREE LED LAMP AND LED STRING LAMP

(76) Inventor: Xingjian CHEN, Taixing (CN)

Correspondence Address: MATTHIAS SCHOLL, 14781 MEMORIAL DRIVE, SUITE 1319, HOUSTON, TX, 77079, US

(21) Appl. No.: 12/173,989

(22) Filed: Jul. 16, 2008

(30) Foreign Application Priority Data
May 23, 2008 (CN) 200820094161.1

(51) Int. Cl. H05B 41/36; H05B 37/02

(52) U.S. Cl. 315/185 S; 315/294

(57) ABSTRACT

A light emitting diode (LED) lamp comprising an LED light (10) and a stabilizing member (20). The LED light (10) comprises a light source (12), a housing (13) for accommodating and packaging the light source (12), and a pair of light pins (11) respectively extending from two ends of the light source (12). The stabilizing member (20) for stabilizing current flowing through the LED light (10) is electrically connected between the pair of light pins (11). An LED lamp string with stabilizing member (20) is also provided. The LED lamp and lamp string will not continuously flicker; the lighting performance is significantly improved, and the lifetime is enhanced, as well.

### CROSS-REFERENCE TO RELATED APPLICATIONS

Pursuant to 35 U.S.C §119 and the Paris Convention Treaty, this application claims the benefit of Chinese Patent Application No. 200820094161.1 filed May 23, 2008, the contents of which are incorporated herein by reference.

### BACKGROUND OF THE INVENTION

1. Field of the Invention

The invention relates to lighting apparatus, and more particularly, to light emitting diode (LED) lamps and lamp strings.

2. Description of the Related Art

LEDs (Light emitting diodes) are increasingly employed as a basic lighting source in a variety of forms. As part of an assembly, LEDs have a longer life compared with common incandescent and fluorescent light sources, and favorable physical properties, including ruggedness, low operating temperature, and ability to operate under a wide temperature range. With the advent of newer doping techniques, LEDs are becoming increasingly efficient; for example, colored LED sources currently available consume on the order of magnitude less power than incandescent bulbs of equivalent light output. Moreover, with expanding applications and resulting larger volume demand, as well as with new manufacturing techniques, LEDs are increasingly cost effective.

However, due to continuous flickering caused by alternating current powering LED lamps, lighting performance is significantly affected, and the lifetime shortened.

Therefore, a heretofore unaddressed need exists to overcome the aforementioned deficiencies and inadequacies.

### SUMMARY OF THE INVENTION

In view of the above-described problems, it is one objective of the invention to provide an LED lamp comprising an LED light and a stabilizing member electrically connected in parallel, for stabilizing supply current flowing through the LED light, and for preventing the LED light from continuously flickering due to alternating current.

To achieve the above objectives, in accordance with one embodiment of the invention, provided is an LED lamp comprising: an LED light comprising a light source, a housing for accommodating and packaging the light; and a stabilizing member for stabilizing current flowing through the LED light electrically connected between a pair of light pins.

In certain classes of this embodiment, the stabilizing member comprises at least one inductor element.

In certain other classes of this embodiment, the stabilizing member further comprises at least one resistor element electrically connected in series to the at least one inductor element.

In certain other classes of this embodiment, the at least one resistor element further comprises at least another one resistor element electrically connected in series to the at least one resistor element.

In certain other classes of this embodiment, the stabilizing member comprises at least two inductor elements electrically connected in series.

In certain other classes of this embodiment, the stabilizing member further comprises at least one resistor element electrically connected in series to the at least two inductor elements.

In certain other classes of this embodiment, the at least one resistor element further comprises at least another one resistor element electrically connected in series to the at least one resistor element.

In certain other classes of this embodiment, the stabilizing member comprises a resistor element and a capacitor element electrically connected in parallel.

In certain other classes of this embodiment, the stabilizing member is disposed below a bowl-shaped cup of the light source.

In certain other classes of this embodiment, the stabilizing member is received in the housing of the LED light.

In view of the above-described problems, it is another objective of the invention to provide an LED lamp string, comprising: a plurality of LED lights and electric wires electrically connected between the LED lights, the LED lights comprising a light source, a housing for accommodating and packaging the light source, and a pair of light pins respectively extending from two ends of the light source; wherein a stabilizing member for stabilizing current flowing through the LED light, is electrically connected between the pair of light pins of the LED light.

In certain classes of this embodiment, the stabilizing member comprises at least one inductor element.

In certain other classes of this embodiment, the stabilizing member comprises at least one inductor element and at least one resistor element electrically connected in series.

In certain other classes of this embodiment, the stabilizing member comprises a resistor element and a capacitor element electrically connected in parallel.

In certain classes of this embodiment, the stability member is disposed in each of the LED lights.

In certain other classes of this embodiment, the stabilizing member is disposed below a bowl-shaped cup of the light source.

In certain other classes of this embodiment, the stabilizing member is received in the housing of the LED light.

In another embodiment of the invention provided is a combination of a first component which is a light emitting diode (LED) having a housing and a second component which is a rectifier, wherein the rectifier is disposed within said housing.

In a class of this embodiment, the combination further comprises a third component which is a smoothing circuit.

In another class of this embodiment, the smoothing circuit is disposed within the housing.

In this invention, since the stabilizing member is added in the LED light of the LED lamp and the LED lamp string, the lighting and decoration performance is significantly improved, and the life of the LED light is enhanced also. Moreover, the LED lamp will not continuously flicker.

### BRIEF DESCRIPTION OF THE DRAWINGS

Other advantages and novel features will become more apparent from the following detailed description when taken in conjunction with the accompanying drawings, in which:

FIG. 1 is a schematic diagram of an LED lamp with a stabilizing member according to the invention;

FIG. 2 is a schematic diagram of an LED lamp with a single inductor in accordance with a first exemplary embodiment of this invention;

FIG. 3 is a schematic diagram of an LED lamp with multiple inductors in accordance with a second exemplary embodiment of this invention;

FIG. 4 is a schematic diagram of an LED lamp with a single inductor combined with a single resistor in accordance with a third exemplary embodiment of this invention;

FIG. 5 is a schematic diagram of an LED lamp with multiple inductors combined with a single resistor in accordance with a fourth exemplary embodiment of this invention;

FIG. 6 is a schematic diagram of an LED lamp with multiple inductors combined with multiple resistors in accordance with a fifth exemplary embodiment of this invention;

FIG. 7 is a schematic diagram of an LED lamp with a resistor combined with a capacitor in accordance with a sixth exemplary embodiment of this invention;

FIG. 8 is a structural diagram of an LED lamp with a stabilizing member according to the invention;

FIG. 9 is a structural diagram of an LED lamp string with a stabilizing member according to one embodiment of the invention; and

FIGS. 10a-10c are schematic diagrams of the stabilizing member depisted in FIG. 8 according to other embodiments of the invention.

### DETAILED DESCRIPTION OF THE INVENTION

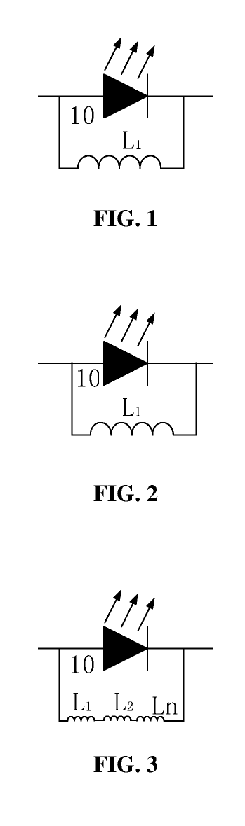

Referring to FIGS. 1 and 8, an LED lamp of this invention comprises an LED light 10 and a stabilizing member 20. The LED light 10 comprises a housing 13, a light source 12, and a pair of light pins 11. The housing 13 is used for accommodating and packaging the light source 12. The light source 12 for generating lighting comprises a cathode frame, an anode frame, and a chip electrically connected between the cathode frame and the anode frame. The light pins 11 respectively extend from two electrode frames of the light source 12, and are connected to electric wires protruding outside of the housing 13. The light source 12 comprises a bowl-shaped cup 14. The stabilizing member 20 is received in the housing 13 and disposed below the bowl-shaped cup 14 of the light source 12, and the stabilizing member 20 is electrically connected between the light pins 11.

The LED lamp of this invention stabilizes supply current flowing through the LED light 10 by means of the stabilizing member 20. The LED light 10 powered by a constant current, the lighting performance is significantly improved, and the lifetime of the LED light 10 is also enhanced.

The stabilizing member 20 is formed in a plurality of manners, and only some of them are described below.

As shown in FIG. 2, the stabilizing member 20 in accordance with a first exemplary embodiment of this invention comprises an inductor element L₁, two ends of the inductor element L₁ are respectively electrically connected to the pair of light pins 11 of the LED light 10. When the LED light 10 is used in a series AC circuit, the current powering the LED can be rectified by the inductor element L₁ having an energy storage function.

As shown in FIG. 3, the stabilizing member 20 in accordance with a second exemplary embodiment of this invention comprises at least two inductor elements L₁-Lₙ. The inductor elements L₁-Lₙ are electrically connected in series.

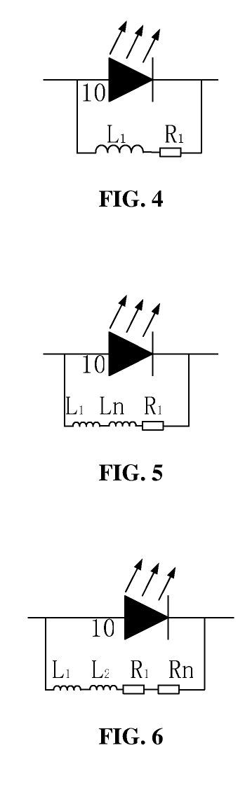

As shown in FIG. 4, the stabilizing member 20 in accordance with a third exemplary embodiment of this invention comprises an inductor element L₁ and a resistor element R₁. The inductor element L₁ and the resistor element R₁ are electrically connected in series to form a filter circuit.

As shown in FIG. 5, the stabilizing member 20 in accordance with a fourth exemplary embodiment of this invention comprises at least two inductor elements L₁-Lₙ and a resistor element R₁. The inductor elements L₁-Lₙ and the resistor element R₁ are electrically connected in series.

As shown in FIG. 6, the stabilizing member 20 in accordance with a fifth exemplary embodiment of this invention comprises at least two inductor elements L₁-Lₙ and at least two resistor elements R₁-Rₙ. The inductor elements L₁-Lₙ and the resistor elements R₁-Rₙ are electrically connected in series.

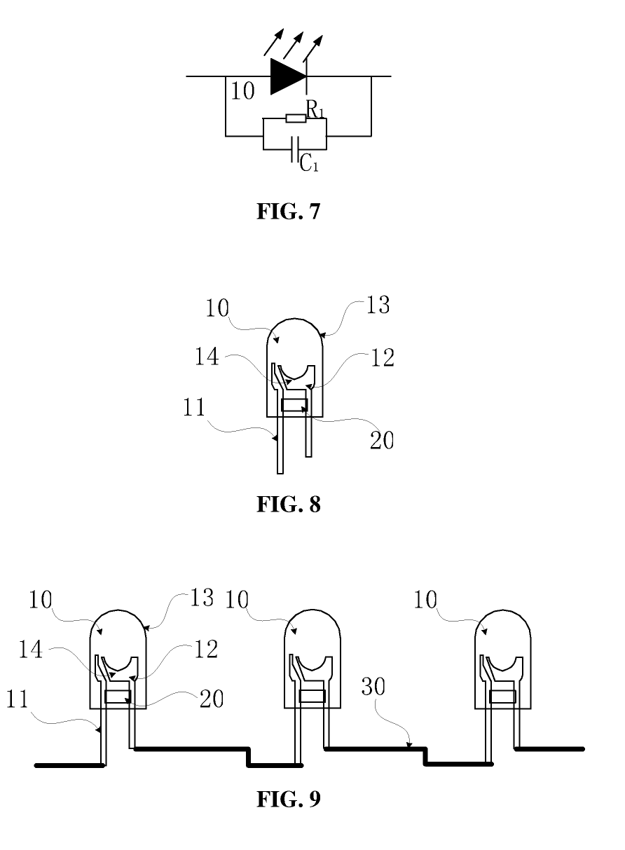

As shown in FIG. 7, the stabilizing member 20 in accordance with a sixth exemplary embodiment of this invention comprises a resistor element R₁ and a capacitor element C₁. The resistor element R₁ and the capacitor element C₁ are electrically connected in parallel.

Referring to FIG. 9, an LED lamp string of this invention comprises a plurality of LED lamps and electric wires 30 electrically connected between the LED lamps. Each LED lamp comprises an LED light 10 having a pair of light pins 11 and a stabilizing member 20 electrically connected between the pair of light pins 11. The LED lamp of the lamp string is the same as the LED lamp of the above description; therefore the description of the LED lamp in the lamp string are omitted.

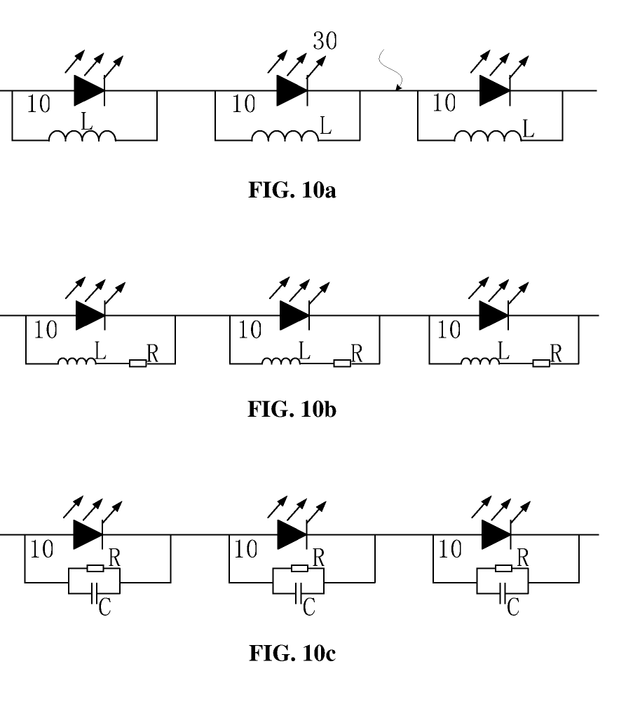

FIGS. 10a-10c illustrate LED lamp strings with the stabilizing member 20 in several embodiments. The stabilizing member 20 of the LED lamp is an inductor element L in FIG. 10a. The stabilizing member 20 of the LED lamp is an inductor element L and a resistor elements R electrically connected in series in FIG. 10b. The stabilizing member 20 of the LED lamp is a capacitor element C and a resistor elements R electrically connected in parallel in FIG. 10c.

A rectifier is an electrical device that converts alternating current (AC) to direct current (DC), a process known as rectification. Rectifiers have many uses including as components of power supplies and as detectors of radio signals. Rectifiers may be made of solid state diodes, vacuum tube diodes, mercury arc valves, and other components.

In order to produce steady DC from a rectified AC supply, a smoothing circuit, sometimes called a filter, is required. In its simplest form this can be what is known as a reservoir capacitor, Filter capacitor or smoothing capacitor, placed at the DC output of the rectifier. There will still remain an amount of AC ripple voltage where the voltage is not completely smoothed.

To further reduce this ripple, a capacitor-input filter can be used. This complements the reservoir capacitor with a choke and a second filter capacitor, so that a steadier DC output can be obtained across the terminals of the filter capacitor. The choke presents high impedance to the ripple current.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A light emitting diode (LED) lamp, comprising:
an LED light (10) comprising a light source (12) having two ends, a housing (13) for accommodating and packaging the light source (12), and a pair of light pins (11) protruding respectively from two ends of the light source (12); and
a stabilizing member (20) for stabilizing current flowing through the LED light (10), said stabilizing member (20) electrically connected between the light pins (11).

2. The LED lamp of claim 1, wherein the stabilizing member (20) comprises at least one inductor element L₁.

3. The LED lamp of claim 2, wherein the stabilizing member (20) further comprises at least one resistor element R₁ electrically connected in series to the at least one inductor element L₁.

4. The LED lamp of claim 3, wherein the at least one resistor element R₁ further comprises at least another one resistor element R₂-Rₙ electrically connected in series to the at least one resistor element R₁.

5. The LED lamp of claim 1, wherein the stabilizing member (20) comprises at least two inductor elements L₁-Lₙ electrically connected in series.

6. The LED lamp of claim 5, wherein the stabilizing member (20) further comprises at least one resistor element R₁ electrically connected in series to the at least two inductor elements L₁-Lₙ.

7. The LED lamp of claim 6, wherein the at least one resistor element R₁ further comprises at least another one resistor element R₂-Rₙ electrically connected in series to the at least one resistor element R₁.

8. The LED lamp of claim 1, wherein the stabilizing member (20) comprises a resistor element R₁ and a capacitor element C₁ electrically connected in parallel.

9. The LED lamp of claim 1, wherein the stabilizing member (20) is disposed below a bowl-shaped cup (14) of the light source (12).

10. The LED lamp of claim 9, wherein the stabilizing member (20) is received in the housing (13) of the LED light.

11. A light emitting diode (LED) lamp string, comprising:
a plurality of LED lights (10) and electric wires (30) electrically connected between the LED lights (10), the LED lights (10) comprising a light source (12), a housing (13) for accommodating and packaging the light source (12), and a pair of light pins (11) respectively extending from two ends of the light source (12); and
a stabilizing member (20) for stabilizing current flowing through the LED light (10);
wherein
said stabilizing member (20) is electrically connected between the pair of light pins (11) of the LED light (10).

12. The LED lamp string of claim 11, wherein the stabilizing member (20) comprises at least one inductor element L.

13. The LED lamp string of claim 11, wherein the stabilizing member (20) comprises at least one inductor element L and at least one resistor element R electrically connected in series.

14. The LED lamp string of claim 11, wherein the stabilizing member (20) comprises a resistor element R and a capacitor element C electrically connected in parallel.

15. The LED lamp string of claim 11, wherein the stability member (20) is disposed in each of the LED lights (10).

16. The LED lamp string of claim 11, wherein the stabilizing member (20) is disposed below a bowl-shaped cup (14) of the light source (12).

17. The LED lamp string of claim 16, wherein the stabilizing member (20) is received in the housing (13) of the LED light (10).

18. A combination of a first component which is a light emitting diode (LED) having a housing and a second component which is a rectifier, wherein said rectifier is disposed within said housing.

19. The combination of claim 18, further comprising a third component which is a smoothing circuit, optionally in combination with a capacitor-input filter.

20. The combination of claim 19, wherein said smoothing circuit is disposed within said housing.
